(19) United States
(12) Patent Application Publication
(10) Pub. No.: US 2020/0409433 A1
(43) Pub. Date: Dec. 31, 2020

(54) Display Storage Assembly

(71) Applicant: David Strobridge, Olympia, WA (US)

(72) Inventor: David Strobridge, Olympia, WA (US)

(21) Appl. No.: 16/454,653

(22) Filed: Jun. 27, 2019

(51) Int. Cl. G06F 1/18; G06F 1/16

(52) U.S. Cl. CPC G06F 1/182; G06F 1/1658; G06F 1/1615

(57) ABSTRACT

A display storage assembly includes a tray that has a first storage area and a second storage area. The tray is positionable in an upright position having the tray angling upwardly from a horizontal support surface. A display is hingedly positioned in the tray. The display is positionable in a deployed position. In this way the display is positioned at an ergonomically preferred angle for viewing the display. A stand is hingedly coupled to the tray. The stand is positionable in a deployed position for retaining the tray in the upright position. A panel is hingedly coupled to the tray. The panel is positionable in a deployed position when the tray is in the upright position to support a keyboard.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to storage devices and more particularly pertains to a new storage device for storing and transporting a display and computer hardware.

### BRIEF SUMMARY OF THE INVENTION

An embodiment of the disclosure meets the needs presented above by generally comprising a tray that has a first storage area and a second storage area. The tray is positionable in an upright position having the tray angling upwardly from a horizontal support surface. A display is hingedly positioned in the tray. The display is positionable in a deployed position. In this way the display is positioned at an ergonomically preferred angle for viewing the display. A stand is hingedly coupled to the tray. The stand is positionable in a deployed position for retaining the tray in the upright position. A panel is hingedly coupled to the tray. The panel is positionable in a deployed position when the tray is in the upright position to support a keyboard.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a display storage assembly according to an embodiment of the disclosure.

FIG. 2 is a right side view of an embodiment of the disclosure showing a tray in an upright position.

FIG. 3 is a front view of an embodiment of the disclosure.

FIG. 4 is a back view of an embodiment of the disclosure.

FIG. 5 is a right side view of an embodiment of the disclosure.

FIG. 6 is an exploded perspective view of an embodiment of the disclosure.

### DETAILED DESCRIPTION OF THE INVENTION

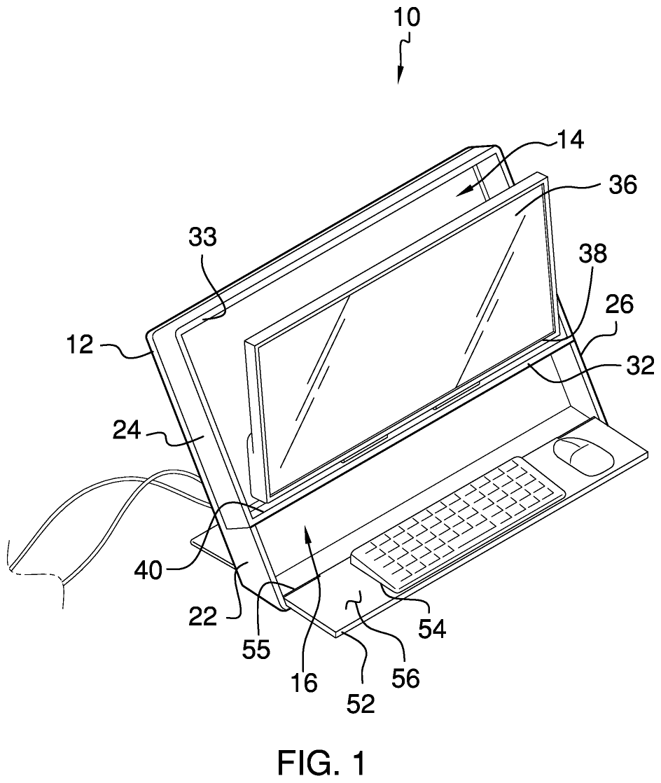

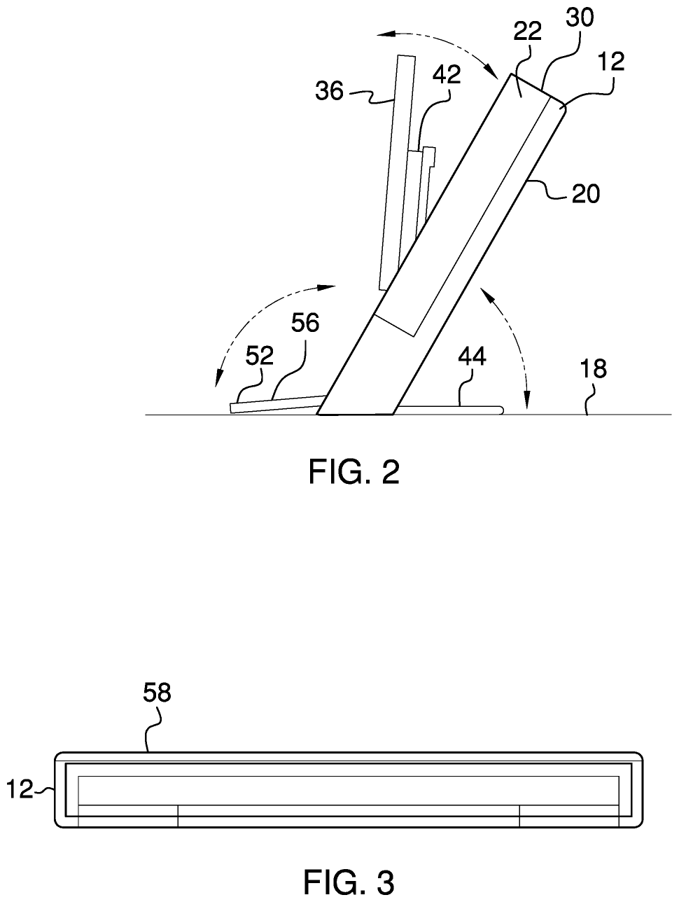

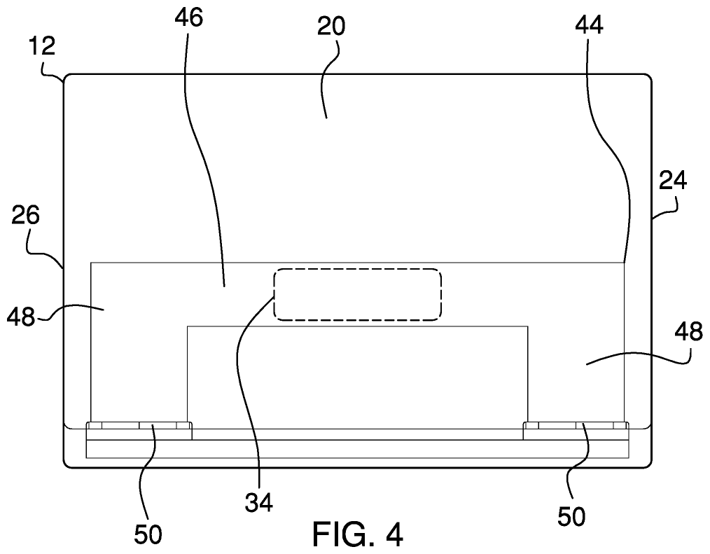

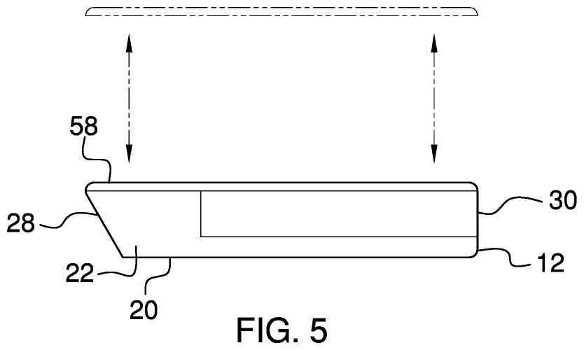

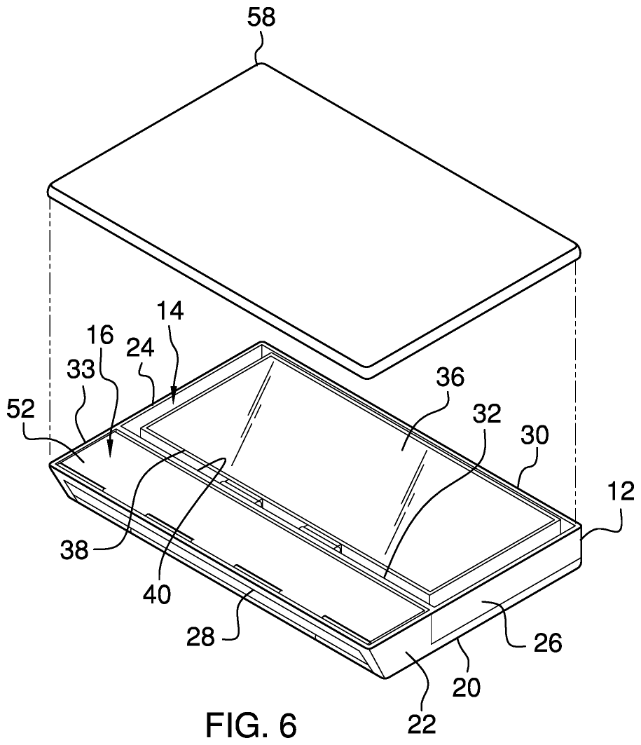

With reference now to the drawings, and in particular to FIGS. 1 through 6 thereof, a new storage device embodying the principles and concepts of an embodiment of the disclosure and generally designated by the reference numeral 10 will be described.

As best illustrated in FIGS. 1 through 6, the display storage assembly 10 generally comprises a tray 12 that has a first storage area 14 and a second storage area 16. The tray 12 is positionable in an upright position having the tray 12 angling upwardly from a horizontal support surface 18, such as a table top or the like. In this way the tray 12 is positioned at an ergonomically preferred angle to be viewed by a user. The tray 12 has a basal wall 20 and a perimeter wall 22 extending away from the basal wall 20, and the perimeter wall 22 has a first lateral side 24, a second lateral side 26, a front side 28 and a back side 30.

A divider 32 is positioned in the tray 12 and the divider 32 extends between the first lateral side 24 and the second lateral side 26 of the perimeter wall 22. The divider 32 defines each of the first storage area 14 and the second storage area 16. The first storage area 14 extends between the back side 30 of the perimeter wall 22 and the divider 32. The second storage area 16 extends between the front side 28 of the perimeter wall 22 and the divider 32. The divider 32 is positioned closer to the front side 28 than the back side 30.

The front side 28 of the perimeter wall 22 is oriented to slope at an acute angle between the basal wall 20 and a distal edge 33 of the perimeter wall 22. The front side 28 rests on the support surface when the tray 12 is positioned in the upright position. Moreover, each of the first lateral side 24 and the second lateral side 26 of the perimeter wall 22 angles upwardly from the support surface when the tray 12 is in the upright position. The tray 12 may width of at least 36.0 inches, a height of at least 24.0 inches and a depth of at least 4.0 inches. The basal wall 20 has a cable opening 34 extending therethrough.

A display 36 is provided and the display 36 is hingedly positioned in the tray 12. The display 36 is positionable in a deployed position when the tray 12 is positioned in the upright position. In this way the display 36 is positioned at an ergonomically preferred angle for viewing the display 36. The display 36 is positionable in a stored position in the first storage area 14. The display 36 has a bottom side 38 and the bottom side 38 is hingedly coupled to a first surface 40 of the divider 32. Additionally, the display 36 angles outwardly from the first storage area 14 when the display 36 is positioned in the deployed position.

The display 36 may be a LCD display for a computer or other similar electronic display. Computer hardware 42, including but not being limited to, a hard disk drive, a motherboard and a processor may be integrated into the display 36. In this way a personal computer may be integrated into the tray 12. The tray 12 is comprised of a fluid impermeable and impact resistant material. In this way the tray 12 protects the display 36 and the computer hardware 42 from impact damage.

A stand 44 is provided and the stand 44 is hingedly coupled to the tray 12. The stand 44 is positionable in a deployed position, and subsequently abuts the support surface for retaining the tray 12 in the upright position. The stand 44 is positionable in a stored position. The stand 44 comprises a central member 46 that extends between a pair of outward members 48. Each of the outward members 48 has a distal end 50 with respect to the central member 46. The distal end 50 of each of the outward members 48 is hingedly coupled to the basal wall 20 of the tray 12. The stand 44 lies against the basal wall 20 when the stand 44 is in the stored position.

The stand 44 angles away from the basal wall 20 at an acute angle when the stand 44 is positioned in the deployed position. The stand 44 lies on the support surface 18 when the tray 12 is positioned in the upright position. Additionally, the stand 44 is resiliently retained in the deployed position to inhibit the tray 12 from tipping rearwardly when the tray 12 is in the upright position. The stand 44 is coextensive with the front side 28 of the perimeter wall 22 of the tray 12.

A panel 52 is provided and the panel 52 is hingedly coupled to the tray 12. The panel 52 is positionable in a deployed position when the tray 12 is in the upright position to support a keyboard 54. The keyboard 54 may be an electronic Qwerty keyboard or the like. The panel 52 is positionable in a stored position having the panel 52 covering the second storage area 16. The panel 52 has a rear edge 55 and a first surface 56. The rear edge 55 is hingedly coupled to the distal edge 33 of the front side 28 of the perimeter wall 22 of the tray 12. The first surface 56 of panel 52 lies on a horizontal plane when the panel 52 is positioned in the deployed position and the tray 12 is in the upright position. In this way the panel 52 positions the keyboard 54 in an ergonomically preferred orientation for typing.

A cover 58 is provided and the cover 58 is removably coupled to the tray 12 when the panel 52 is positioned in the stored position. The cover 58 engages the distal edge 33 of the perimeter wall 22 of the tray 12. Additionally, the cover 58 completely covers each of the first storage area 14 and the second storage area 16 in the tray 12. The cover 58 is comprised of an impact resistant material for protecting the display 36 and the keyboard 54.

In use, the cover 58 is removed from the tray 12 and the stand 44 is positioned in the deployed position. The tray 12 is stood on the front side 28 of the perimeter wall 22 of the tray 12 and the stand 44 retains the tray 12 in the upright position. The display 36 is positioned in the deployed position and the panel 52 is positioned in the deployed position. In this way the display 36 and the keyboard 54 are each positioned in the preferred ergonomic orientation. Cabling for the display 36, the keyboard 54 and any other computer hardware 42 are ran through the cable opening 34 the basal wall 20 of the tray 12. In this way the tray 12, the display 36 and the panel 52 define a portable work station for computer work.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A display storage assembly being configured to store an electronic display and an electronic keyboard, said assembly comprising:
a tray having a first storage area and a second storage area, said tray being positionable in an upright position having said tray angling upwardly from a horizontal support surface wherein said tray is configured to be positioned at an ergonomically preferred angle to be viewed by a user, said tray having a basal wall and a perimeter wall extending away from said basal wall, said perimeter wall having a first lateral side, a second lateral side, a front side and a back side, said tray having a divider therein, said divider extending between said first lateral side and said second lateral side of said perimeter wall to define each of said first storage area and said second storage area, said first storage area extending between said back side of said perimeter wall and said divider, said second storage area extending between said front side of said perimeter wall and said divider, said front side of said perimeter wall being oriented to slope at an acute angle between said basal wall and a distal edge of said perimeter wall, said front side abutting the support surface when said tray is positioned in said upright position such that each of said first lateral side and said second lateral side of said perimeter wall angles upwardly from the support surface;
a display being hingedly positioned in said tray, said display being positionable in a deployed position when said tray is positioned in said upright position wherein said display is configured to be positioned at an ergonomically preferred angle for viewing said display, said display being positionable in a stored position in said first storage area;
a stand being hingedly coupled to said tray, said stand being positionable in a deployed position extending from said tray angled similarly to said front side wherein said stand is configured to abut the support surface for retaining said tray in said upright position, said stand being positionable in a stored position; and
a panel being hingedly coupled to said tray, said panel being positionable in a deployed position when said tray is in said upright position wherein said panel is configured to support a keyboard, said panel being positionable in a stored position having said panel covering said second storage area.

2. The assembly according to claim 1, wherein said divider is positioned closer to said front side than said back side.

3. (canceled)

4. The assembly according to claim 1, wherein said display has a bottom side, said bottom side being hingedly coupled to a first surface of said divider, said display being angling outwardly from said first storage area when said display is positioned in said deployed position.

5. The assembly according to claim 1, wherein said stand comprises a central member extending between a pair of outward members, each of said outward members having a distal end with respect to said central member, said distal end of each of said outward members being hingedly coupled to said basal wall of said tray, said stand lying against said basal wall when said stand is in said stored position, said stand angling away from said basal wall at an acute angle when said stand is positioned in said deployed position wherein said stand is configured to lie on the support surface when said tray is positioned in said upright position, said stand being coextensive with said front side of said perimeter wall of said tray.

6. The assembly according to claim 5, wherein said stand is resiliently retained in said deployed position to inhibit said tray from tipping rearwardly when said tray is in said upright position.

7. The assembly according to claim 1, wherein said panel has a rear edge and a first surface, said rear edge being hingedly coupled to said distal edge of said front side of said perimeter wall of said tray, said first surface of panel lying on a horizontal plane when said panel is positioned in said deployed position and said tray is in said upright position wherein said panel is configured to position the keyboard in an ergonomically preferred orientation for typing.

8. A display storage assembly being configured to store an electronic display and an electronic keyboard, said assembly comprising:
a tray having a first storage area and a second storage area, said tray being positionable in an upright position having said tray angling upwardly from a horizontal support surface wherein said tray is configured to be positioned at an ergonomically preferred angle to be viewed by a user, said tray having a basal wall and a perimeter wall extending away from said basal wall, said perimeter wall having a first lateral side, a second lateral side, a front side and a back side, said tray having a divider therein, said divider extending between said first lateral side and said second lateral side of said perimeter wall to define each of said first storage area and said second storage area, said first storage area extending between said back side of said perimeter wall and said divider, said second storage area extending between said front side of said perimeter wall and said divider, said divider being positioned closer to said front side than said back side, said front side of said perimeter wall being oriented to slope at an acute angle between said basal wall and a distal edge of said perimeter wall, said front side abutting the support surface when said tray is positioned in said upright position such that each of said first lateral side and said second lateral side of said perimeter wall angles upwardly from the support surface;
a display being hingedly positioned in said tray, said display being positionable in a deployed position when said tray is positioned in said upright position wherein said display is configured to be positioned at an ergonomically preferred angle for viewing said display, said display being positionable in a stored position in said first storage area, said display having a bottom side, said bottom side being hingedly coupled to a first surface of said divider, said display being angling outwardly from said first storage area when said display is positioned in said deployed position;
a stand being hingedly coupled to said tray, said stand being positionable in a deployed position extending from said tray angled similarly to said front side wherein said stand is configured to abut the support surface for retaining said tray in said upright position, said stand being positionable in a stored position, said stand comprising a central member extending between a pair of outward members, each of said outward members having a distal end with respect to said central member, said distal end of each of said outward members being hingedly coupled to said basal wall of said tray, said stand lying against said basal wall when said stand is in said stored position, said stand angling away from said basal wall at an acute angle when said stand is positioned in said deployed position wherein said stand is configured to lie on the support surface when said tray is positioned in said upright position, said stand being resiliently retained in said deployed position to inhibit said tray from tipping rearwardly when said tray is in said upright position, said stand being coextensive with said front side of said perimeter wall of said tray; and
a panel being hingedly coupled to said tray, said panel being positionable in a deployed position when said tray is in said upright position wherein said panel is configured to support a keyboard, said panel being positionable in a stored position having said panel covering said second storage area, said panel having a rear edge and a first surface, said rear edge being hingedly coupled to said distal edge of said front side of said perimeter wall of said tray, said first surface of panel lying on a horizontal plane when said panel is positioned in said deployed position and said tray is in said upright position wherein said panel is configured to position the keyboard in an ergonomically preferred orientation for typing.
